(19) United States
(12) Patent Application Publication
(10) Pub. No.: US 2014/0280321 A1
(43) Pub. Date: Sep. 18, 2014

(54) SYSTEMS, METHODS AND MEDIA FOR PROVIDING A CUSTOMIZED OUTPUT BASED ON DATA OBTAINED USING RADIO-FREQUENCY IDENTIFICATION (RFID)

(71) Applicant: APPSENSE LIMITED, Santa Clara, CA (US)

(72) Inventor: Joseph SAIB, Santa Clara, CA (US)

(73) Assignee: APPSENSE LIMITED, Warrington (GB)

(21) Appl. No.: 13/797,304

(22) Filed: Mar. 12, 2013

(51) Int. Cl. G06K 7/10

(52) U.S. Cl. CPC G06K 7/10366
USPC 707/770

(57) ABSTRACT

Systems, methods and media are provided for providing a customized output based on data obtained using RFID. One method includes receiving from at least one RFID reader identification (ID) information stored in a plurality of RFID devices. The method also includes searching and gathering data related to a plurality of individuals carrying the plurality of RFID devices from at least one of a database and an online source based on the ID information. The databases include personal information corresponding to each of the plurality of individuals. The method further includes analyzing the gathered data to update the personal information and to search for additional data related to the individuals and correlating the gathered data and the updated personal information to derive relationships amongst the individuals. The method also includes providing a customized output using at least one of the gathered data, the updated personal information and the derived relationships.

### TECHNICAL FIELD

Disclosed systems, methods and media relate to providing a customized output based on data obtained using information stored in radio-frequency identification (RFID) devices. Specifically, disclosed systems, methods and media relate to providing an output that is customized for one or more individuals each carrying an RFID device based on data that is obtained using the RFID of that individuals.

### BACKGROUND

Radio-frequency identification (RFID) is used for identification and/or tracking of an object or a person. Typically, an RFID device is a small electronic device that includes an antenna and a microchip capable of storing data. Some RFID devices (e.g., RFID tags) require no power source (e.g., battery) and are powered and read at short ranges via a mechanism based on electromagnetic induction. Other RFID devices use a local source, such as a battery, and emit radio waves (i.e., electromagnetic radiation at radio frequencies) that include the information stored in the microchip.

Passive RFID devices such as RFID tags are used in many industries. For example, an RFID tag may be attached to an automobile during production to track its progress through an assembly line. RFID tags may be also attached to pharmaceuticals for tracking through warehouses. They may be also attached to livestock and pets for positive identification of the animal(s).

### SUMMARY

In accordance with the disclosed subject matter, systems, methods and media are provided for providing a customized output based on data obtained using information stored in radio-frequency identification (RFID) devices. Specifically, disclosed systems, methods and media can provide an output that is customized for one or more individuals each carrying an RFID device based on data that is obtained using RFIDs of the individuals.

The disclosed subject matter includes a method. The method can include receiving, at a server, from at least one RFID reader, identification (ID) information stored in a plurality of RFID devices each carried by one of a plurality of individuals. The method also includes searching and gathering, at the server, data related to the plurality of individuals from at least one of a database and an online information source based on the ID information. The database includes personal information corresponding to each of the plurality of individuals. The method further includes analyzing, at the server, the gathered data to update the personal information corresponding to each of the plurality of individuals and searching for additional data related to the plurality of individuals from at least one of the database and the online information source based on the updated personal information. The method also includes correlating, at the server, the gathered data and the updated personal information to derive relationships amongst the plurality of individuals and providing a customized output for at least some of the plurality of individuals using at least one of the gathered data, the updated personal information and the derived relationships

The method further includes generating, at the server, for output to at least some of the plurality of individuals at least one question based in part on at least one of the gathered data, the updated personal information and the derived relationships. The method also includes receiving and gathering, at the server, answers to the question from at least some of the plurality of individuals. The customized output is further based on the gathered answers.

The method further includes monitoring, at the server, a plurality of parameters related to a controlled system. The method also includes detecting and gathering, at the server, inputs from at least one of the plurality of individuals indicating a change of at least one of the plurality of parameters. The customized output is further based on the gathered inputs and includes a control signal provided to the controlled system.

In some embodiments, the plurality of RFID devices includes a plurality of RFID cards and/or RFID tags. In some embodiments, the database is a remote database operated by a third party and the server maintains a subscription with the third party for the remote database. In some embodiments, searching from the databases includes making queries using an outcome of a search from the online information source in addition to the ID information. In some embodiments, searching from the online information source includes making queries using an outcome of a search from the database in addition to the ID information.

In some embodiments, correlating the gathered data and the updated personal information includes pooling information in at least one category of the gathered data and the updated personal information and identifying any individuals from the plurality of individuals with matching information item within the category. In some embodiments, the online information source includes a plurality of file transfer protocol (FTP) site, online storage site, web site, online auction site, online dating site, content site, e-commerce site, government site, school site, religious site, blog site, forum site, social media networking site, community site, online message board and online chat room.

The disclosed subject matter also includes an apparatus for providing a customized output based on data obtained using RFIDs. The apparatus can include one or more interfaces configured to provide communication with at least one node over a network. The apparatus can also include a processor, in communication with the one or more interfaces, configured to run a customized output generation module stored in memory that is configured to receive, from at least one RFID reader, identification (ID) information stored in a plurality of RFID devices each carried by one of a plurality of individuals. The customized output generation module run by the processor can be also configured to search and gather data related to the plurality of individuals from at least one of a database and an online information source based on the ID information. The database includes personal information corresponding to each of the plurality of individuals. The customized output generation module run by the processor can be also configured to analyze the gathered data to update the personal information corresponding to each of the plurality of individuals and search for additional data related to the plurality of individuals from at least one of the database and the online information source based on the updated personal information. The customized output generation module run by the processor can be also configured to correlate the gathered data and the updated personal information to derive relationships amongst the plurality of individuals and provide a customized output for at least some of the plurality of individuals using at least one of the gathered data, the updated personal information and the derived relationships.

The disclosed subject matter further includes a non-transitory computer readable medium. The computer readable medium can have executable instructions operable to cause an apparatus to receive, from at least one RFID reader, identification (ID) information stored in a plurality of RFID devices each carried by one of a plurality of individuals. The executable instructions are also operable to cause an apparatus to search and gather data related to the plurality of individuals from at least one of a database and an online information source based on the ID information. The database includes personal information corresponding to each of the plurality of individuals. The executable instructions are further operable to cause an apparatus to analyze the gathered data to update the personal information corresponding to each of the plurality of individuals and search for additional data related to the plurality of individuals from at least one of the database and the online information source based on the updated personal information. The executable instructions are also operable to cause an apparatus to correlate the gathered data and the updated personal information to derive relationships amongst the plurality of individuals and provide a customized output for at least some of the plurality of individuals using at least one of the gathered data, the updated personal information and the derived relationships.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 is flow diagram for providing a customized output based on data obtained using radio-frequency identification (RFID) in accordance with certain embodiments of the disclosed subject matter.

FIG. 3 is a block diagram of a server device in accordance with certain embodiments of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems, methods and media that are within the scope of the disclosed subject matter.

The disclosed subject matter relates to systems, methods and media for providing a customized output based on data obtained using information stored in radio-frequency identification (RFID) devices. The disclosed systems, methods and media provide ways in which an output that is customized for an individual or a group of individuals can be generated using data that is collected and correlated based on the information obtained from the RFID devices carried by a plurality of individuals. In some embodiments, the collected data includes demographic information, information from social media sites, such as Facebook or Twitter, public information from the Internet, information about prior visits to a particular location, personal information, and any other suitable information or combination of information. In some embodiments, the customized output includes recommendations, discount coupons, location information, and any other suitable suggestions, solicitations, or combination thereof.

In one embodiment, for example, a corporate executive is on vacation and decides to visit her hometown where she grew up and graduated from a local public high school. She carries a radio-frequency identification (RFID) device that includes information that can be used to identify her. She decides to dine in a chain restaurant in the town. As she walks into the chain restaurant, an RFID reader installed at the entrance of the restaurant reads the information stored in the executive's RFID device. The executive is greeted by a host of the restaurant and is waiting to be seated. While she waits to be seated, the information read from her RFID device (“ID data”) is transmitted from the RFID reader to a server owned and operated by the restaurant chain in a regional corporate data center. The server analyzes her ID data and starts gathering publicly available information about the executive.

Using the executive's ID data, for example, the server sends queries to several database systems, including one or more database systems owned and operated by private providers/vendors with whom the restaurant chain has commercial and/or business relationships. For instance, the restaurant chain may have a contractual relationship with a social media company that operates a database system including tweets exchanged amongst its members. As the server gathers more information, it uses the additional information to make more specific and refined searches. For instance, as the server finds out about the executive's job title, her employer and her residential address, the server also begins searching other public domains, such as web sites for media companies and publishers that are located and operating near her employer and/or in the city where she lives, to gather as much information about her. The server also correlates the data gathered for the executive with the data gathered for others dining in the same restaurant to determine, e.g., whether two old friends happen to dine in the same place, etc.

Through the database queries and other searches, the server quickly learns, among other things, the executive's title and employer, residential address, some of her personal and commercial affiliations, her family relations, her marital status, her education history, etc. Once the server gathers all the data that it can gather, it further analyzes the gathered data to generate information that can be used to better serve the executive. For instance, the server can deduce from the gathered data that she is visiting her hometown where she grew up, that she graduated from a local public high school, that she was the valedictorian of her high school class, that she is single, that her mother (e.g., Mrs. Anderson) still lives in the town and used to teach 3rd graders in a local junior high school, that a man who graduated from the same local high school in the same year happens to be dining in the restaurant, that her birthday is only few days away, and that she held her birthday party in the restaurant few years ago. This information is then selectively (e.g., for privacy protection and personal security reasons) communicated to the manager of the restaurant and her waiter/waitress so that the information can be used to better serve the executive.

It should be noted that though the server can search and gather much information about the executive, including sensitive personal information. In many, if not in all cases, the server can be carefully configured not to communicate such sensitive personal information to human agents. For example, though the restaurant chain's server may gather and use the executive's home address and the name of her employer, it may not communicate such personal information to the waitress and the manager.

When the executive is seated, for example, her waitress can come to greet her with more specific and friendly messages, such as, “Welcome back to hometown, Sally! How is Mrs. Anderson? She was my math teacher. Today, we have a chef's special dish including pork chop and sautéed spinach that also comes with your favorite desert, our signature cheesecake. Would you like to try that?” The restaurant manager can also stop by and inform the executive that there is a gentleman dining in the restaurant who was in her high school class and ask her if she would be interested in finding out his name. If she expresses her interest in finding out his name, then the manager may ask the same question to the man (to respect the privacy of both Sally and her classmate), and if everything goes well, the two old high schoolers may get a chance to reacquaint each other. The manager may also get a chance to thank the executive for holding a birthday party few years ago and inform her a new discount program for loyal customers. With all the customized greetings and suggestions, Sally, the executive, feels at home while enjoying her favorite dish and desert and the opportunity to reacquaint a man who used to go to school together. Sally has better time in the restaurant and the restaurant just increase the chance of her coming back to the restaurant.

In another embodiments, a family of six, each family member carrying an RFID device, arrives at the airport and approaches a boarding pass kiosk of an airline company. An RFID reader in the kiosk reads the information stored in the RFID device (“ID information”) of each of the family member and sends the ID information to a server located at the airline's data center. The airline's server obtains data related to the family members from the airline's customer database using the ID information. For example, the server first gathers data regarding the family of six as well as data related to each member of the family using the ID information. For instance, the server finds out that one of the six members is an aging woman in her 70s (grandmother) but the remaining members are in their 40s (Mom and Dad) and teens (children). The server analyzes the personal information pertinent to each family member and determines that the sum of the mileage points of each individual family member is sufficient to upgrade one of the six tickets for a seat in the business class. Based on these findings, the server outputs a set of instructions to the kiosk, causing the kiosk to inform the family of an offer of the upgrade and, if the offer is accepted, print five coach class tickets for the younger members of the family and one business class ticket for the grandmother.

The two embodiments described above—for the executive and the family—are merely exemplary. The invention can be applied to any suitable information collected for any suitable individual or group of individuals in any suitable setting.

FIG. 1 illustrates a diagram of a networked communication arrangement in accordance with an embodiment of the disclosed subject matter. The networked communication arrangement 100 can include a communication network 102, a server 104, at least one client device 106 (e.g., client devices 106-1, 106-2, . . . 106-N), at least one user device 110 (e.g., user devices 110-1, 110-2, . . . 110-N) and a database 108.

Each client device 106 can send data to, and/or receive data from, the server 104 over the communication network 102. Each client device 106 can be directly coupled to the server 104; alternatively, each client device 106 can be connected to the server 104 via any other suitable device(s), communication network(s), or combination thereof. For example, each client device 106 can be coupled to the server 104 via one or more routers, switches, access points, and/or communication networks (as described below in connection with communication network 102). Each user device 110 can store a user's radio-frequency identification (RFID) that can be transmitted to, or electronically read by, an RFID reader. In some embodiments, a user device 110 may be an RFID card or an RFID tag. In some embodiments, a user device 110 may be a mobile device (e.g., mobile phone, smartphone) including integrated RFID component(s) (e.g., RFID microchip, RFID antenna, etc.).

A client device 106 can include a desktop computer, a mobile computer, a tablet computer, a cellular device, a smartphone or any computing system that is capable of performing computation. A client device 106 can also include a near field communication (NFC) reader or a radio frequency identification (RFID) detector; alternatively, it could be a device that collects data from a network of NFC readers and/or RFID detectors. For example, a client device 106 can be an RFID reader installed on an entrance of a shopping mall, a retail store, a restaurant, a bar, or a company that can read the information stored in user devices 110 (also referred to as RFID devices) carried by any suitable individuals including customers, shoppers, employees, or visitors.

The server 104 can be a single server, or a network of servers, or a farm of servers in a data center. For example, the server 104 may be a server located in a retail business or a company or a data center for the retail business or the company, e.g., for receiving and processing information stored in RFID devices, that is transmitted from NFC readers/RFID detectors located in any suitable locations, including the retail store/business and the company. The server 104 may also receive and process information that is stored and transmitted from customers' smartphones. For instance, the server 104 may run one or more processes that can interact with software applications running on the customers' smartphones to receive and process information related to the customers. In some embodiments, the server 104 can be a processing unit that receives and processes identification (ID) information stored in an RFID device and provides a customized output signal, such as a control signal.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above. For instance, a network of NFC readers and/or RFID detectors and one or more servers located in a retail store/business may form a part of a local area network, and such local servers may be connected to form a private WAN for the retail chain. In some embodiments, the communication network 102 includes a network of components connected to one or more data buses.

The server 104 can be coupled to a database system. The database 108 can include at least one of two types of database: a local database and a remotely located database. The database 108 can include any data supported by one or more of data structures; alternatively, it could include one or more database management system (DBMS) or a distributed database. For example, the database 108 may include a data structure, or one or more data tables in a DBMS, for storing information related to retail customers, such as customer ID, home/office addresses, telephone number(s), email address(es), purchase history, accrued loyalty points, etc. The database 108 can also include at least one of a relational database, object database (a.k.a., object-oriented database), XML database, cloud database, active database, and a data warehouse. The database 108 may include at least one physical, non-transitory storage medium. In some embodiments, the database 108 can be a local storage medium (e.g., memory, disk) including a data structure.

In some embodiments, the database 108 can be provided as an enterprise system in a corporate environment For example, the communication network 102, the (proxy) server 104, the client devices 106, and the database 108 can be located in a close proximity and can be a part of a single company. In some cases, the (proxy) server 104, the client devices 106, and the database 108 can be located in the same building and can be coupled to one another via a local communication network. The local communication network can include a local area network (LAN), a corporate network, and a virtual private network (VPN) associated with the corporate network. FIG. 1 shows the database 108 as separate from the communication network 102. However, the database 108 can be part of communication network 102 or another communication network.

FIG. 2 is flow diagram 200 for providing a customized output based on data obtained using radio-frequency identifications (RFIDs) in accordance with certain embodiments of the disclosed subject matter. At 202, information stored in radio-frequency identification (RFID) devices (“ID information”) is read. For example, an RFID reader installed at a particular location can read ID information of the individuals carrying an RFID tag who go through the location. In some embodiments, the ID information stored in an RFID device includes identification information of the device owner, such as the owner's name and/or one or more identification numbers associated with the owner. In some embodiments, the RFID device may be a RFID card or a RFID tag containing an antenna and a microchip. For example, an RFID reader installed at an entrance of a shopping mall can read ID information stored in RFID tags carried by the prospective shoppers and transmit the ID information to a server for further processing.

At 204, data related to the owners of the RFID devices are gathered. For example, a server that receives the ID information collected at one or more RFID readers can begin searching for more information related to the individuals carrying the RFID devices using the collected ID information. For example, the server can search one or more databases that the server's operator maintains to gather information about each of the individuals. In some embodiments, the server also sends queries to one or more databases that are maintained by third parties. In some embodiments, the server may also search for web sites, social media sites/services and other available information sources.

Returning to the shopping mall example, for instance, when a server operate by the shopping mall receives the ID information of the prospective shoppers entering the shopping mall, the server checks databases that are maintained by the shopping mall to gather any available information regarding each of the prospective shoppers, such as purchasing history, observed shopping habits, average time that the shopper spends once he/she comes to the mall, etc. The server also generates and sends queries to databases that are maintained by third party database operators as well as publicly available information sources to gather further information. For instance, the server may find out from a social media network site that a prospective shopper (“Jane”) is planning on holding a surprise birthday party for her spouse (“Tom”) in the next few days. The server may also learn from tweets that Jane has sent and received that Jane recently purchased a new smartphone. The server may further learn from an Internet merchant that Jane has recently requested a quote for auto insurance.

At 206, the data gathered using the ID information at 204 is analyzed and correlated. For example, a server that collects ID information from RFID reader(s) can analyze the gathered data to derive additional information or to fine-tune the existing data. The server can also delete, modify or replace part(s) of the existing data that prove to be inaccurate or incorrect. In some embodiments, the server can conduct additional searches and/or database queries using the refined and/or corrected data to further advance the data gathering effort. The server can also correlate the gathered data for one individual with one or more other individuals to derive relationships amongst a group of individuals.

Returning to the shopping mall example, for instance, the shopping mall's server can analyze the data gathered for Jane to update Jane's marital status from “single” to “married” based on the information gathered from the social media network site, update her information to indicate that she owns and drives a car based on the information gathered from the Internet merchant, and replaces the model of her mobile device from an aging mobile phone to an up-to-date smartphone based on her recent purchasing history. The server, having just learned that Tom is Jane's spouse, can also correlate the data gathered for Jane and Tom to derive one or more relationships. For example, the server can analyze Jane's family, personal and business relationships with respect to Tom and his relationships with others and derive new relationships for both Jane and Tom. For instance, the server can update Jane's relationship with Tom's father, who happens to be an avid golfer and loves fishing.

The server could also correlate and match the data gathered for all the individuals who stay in the mall at any given time to determine whether there are individuals who may be interested in learning that they happen to be in the mall at the same time. For example, the server can correlate and match information related to social media service membership status of each individual present at the mall and determine whether there are a group of individuals who belong to a same social media service or a same twitter group. The server can also correlate and match information related to educational background of each individual present at the mall and determine whether there are a group of individuals who graduated from a same high school or college. Returning to the shopping mall example, for instance, the server may learn that three individuals who graduated from a same high school in a same year (e.g., 2007) happen to be present in the mall and Jane is one of them. The server may also learn that there is a retired school teacher who taught mathematics in the same high school around 2007.

At 208, inputs are gathered directly from the owners of the RFID devices using the data gathered at 204 and the relationships derived at 206. For example, a server that collects RFID information from RFID reader(s) can optionally formulate questions based on the data gathered for one or more individuals and present the questions to the individuals to gather direct inputs from them. Returning to the shopping mall example, for instance, the server, having learned that Jane is married to Tom and knowing that Father's Day is fast approaching, may send a text message to Jane, asking whether she would like to receive a discount coupon for a sports equipment shop in the mall that includes separate sections for golf clubs and fishing rods.

The server may also send a text message to Jane and the other two individuals who graduated from the same high school in 2007, informing each of the three about the other two classmates and asking whether he/she would mind meeting them. If at least two of the three indicate in response to the text message that they are interested in meeting their classmates, the server can then provide an arrangement for an instant meeting in the mall.

At 210, customized output(s) are generated based on the data gathered at 204 using ID information collected from RFID reader(s), the relationships derived at 206 and the inputs optionally gathered directly from the owners of the RFID devices at 210. For example, the server that gathered data at 204, 206 and inputs from RFID device owners at 210, or a server that received the gathered data/inputs from such server(s), can generate output(s) that are customized for each individual RFID device owner. Returning to the shopping mall example, the shopping mall server, having gathered data for, and, in some instances, inputs from, those carrying an RFID device can use the data/inputs to generate customized outputs for the RFID device owner(s). For instance, the server may send Jane information about a special offer for a group gathering or a party at a movie theater located in the mall. The server can also send Jane via email images of smartphone accessories that are sold at an accessory shop in the mall.

If Jane's input in response to the offer of the discount coupon for the sports equipment shop is positive, then the server may also send Jane an electronic version of the discount coupon. If, in addition, Jane and at least one of the remaining two 2007 classmates indicate that they are interested in meeting their classmates, the server can send a text message including a time and a place in the mall (e.g., at the coffee shop located on the first floor next to Macy's™ department store in the northern wing of the mall in the next 15 minutes) to Jane and her classmates. The server can also inform Jane that her high school math teacher also happens to be shopping at the mall and that the teacher expressed her interest in meeting her former student. If Jane too is interested in meeting her high school math teacher, she can indicate as such and the server can provide Jane's contact number to her teacher, along with a discount coupon that can be used at café in the mall, so that they can meet at the mall.

FIG. 3 is a block diagram 300 of a server device in accordance with certain embodiments of the disclosed subject matter. The block diagram 300 shows a server 104, which includes a processor 302, a memory 304, interfaces 306, 310, 312, and 314, a customized output generation module 308, a database 108, an Intranet 316, and the Internet 318. The memory 304 and the interfaces 306, 310, 312, and 314 are communicatively coupled to the processor 302. The server 104 can communicate with client devices 106 (not shown) via the interface 306; the server 104 can communicate with the database 108 via the interface 310; the server 104 can communicate with the Intranet 316 via the interface 312; and the server 104 can communicate with the Internet 318 via the interface 314. The interfaces 306, 310, 312, and 314 are shown as separate interfaces but may be the same physical interface. The processor 302 can run software programs and modules, including the customized output generation module 308. The memory 304 is capable of storing data that can be used by the processor 302 to run the software programs and modules.

The customized output generation module 308 can be configured to communicate, or interact, with one or more client devices 106 through the interface 306 for providing a customized output based on data obtained using information stored in radio-frequency identification (RFID) device. For example, the customized output generation module 308 can receive from at least one RFID reader identification (ID) information stored in a plurality of RFID devices each carried by an individual. The customized output generation module 308 can also gather data related to individuals carrying the plurality of RFID devices using the ID information by searching at least one of one or more local databases, one or more remote databases and a plurality of online sites and online forums. In some embodiments, the one or more local databases include personal information related to the individuals.

The customized output generation module 308 can further analyze the gathered data to update the personal information and to perform additional and more refined database and online searches using the updated personal information and correlate the gathered data and the updated personal information to derive relationships amongst the individuals. The customized output generation module 308 can also provide a customized output for at least some of the plurality of individuals using at least one of the gathered data, the updated personal information and the derived relationships.

In some embodiments, the customized output generation module 308 can gather inputs from at least some of the individuals by generating and presenting one or more questions to the at least some of the individuals and collecting answers to the one or more questions, wherein the one or more questions are generated based at least in part on one or more of the gathered data, the updated personal information and the derived relationships and wherein the customized output is provided using the gathered inputs in addition to the at least one of the gathered data, the updated personal information and the derived relationships.

In some embodiments, the customized output generation module 308 can gather inputs from at least one of the individuals by monitoring a plurality of parameters related to a controlled system and detecting changes of at least one of the plurality of parameters caused by the at least one of the individuals, wherein the customized output is provided using the gathered inputs in addition to the at least one of the gathered data, the updated personal information and the derived relationships and wherein the customized output includes a control signal provided to the controlled system.

In some embodiments, the customized output generation module 308 can search the one or more remote databases by making queries using at least one of an outcome of the local database searches and an outcome of the online searches in addition to the ID information. In some embodiments, the customized output generation module 308 can search the plurality of online sites and the online forums by searching the online sites and the online forums using at least one of an outcome of the local database searches and an outcome of the remote database searches in addition to the ID information. In some embodiments, the customized output generation module 308 can correlate the gathered data and the updated personal information by pooling information in one or more categories of the gathered data and the updated personal information and identifying individuals with matching information within the one or more categories.

FIG. 3 shows a server 104 having the customized output generation module 308 that performs the above-described operations in accordance with certain embodiments of the disclosed subject matter. The server 104 may include additional modules, less modules, or any other suitable combination of modules that perform any suitable operation or combination of operations.

The interfaces 306, 310, 312, and 314 provide an input and/or output mechanism to communicate over a network. The interfaces 306, 310, 312, and 314 enable communication with clients, as well as other network nodes in the communication network 102. The interfaces 306, 310, 312, and 314 can be implemented in hardware to send and receive signals in a variety of mediums, such as optical, copper, and wireless, and in a number of different protocols some of which may be non-transient.

The server 104 can operate using operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

The user device 110 includes an RFID tag or an RFID card. The user device 110 can also include a user equipment, such as a cellular phone having phonetic communication capabilities as well as RFID components, such as an RFID microchip and an RFID antenna. The user device 110 can also be a smart phone providing services such as word processing, web browsing, gaming, e-book capabilities, an operating system, and a full keyboard. The user device 110 can also be a tablet computer providing network access and most of the services provided by a smart phone. The user device 110 can operate using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user device 110 can also keep global positioning coordinates, profile information, or other location information.

The client device 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 106 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The client device 106 can also provide a variety of user interfaces such as a keyboard, a touch screen, a trackball, a touch pad, and/or a mouse. The client device 106 may also include speakers and a display device in some embodiments.

The disclosed systems, methods and media provide ways in which an output that is customized for an individual or a group of individuals can be generated using data that is collected and correlated based on the information collected from the RFID devices carried by a plurality of individual. In some embodiments, for example, a family of four (e.g., a husband, a wife and the couple's two children) has a mid-size sedan that includes an automatic comfort system. The automatic comfort system can detect the number of passengers in the sedan as well as the identities of the passengers and adjust a comfort setting, including a preferred temperature and seat reclining for each passenger. The sedan has several RFID readers in the interior that are connected to a network of sensors and other components, such as a server processing unit and a memory.

In the morning of a summer week day, all four members of the family, each carrying an RFID tag, ride the sedan together to go to work, school and nursery and for a shopping. The RFID readers in the interior of the sedan read the identification (ID) information stored in the RFID tags and send the ID information to the server processor in the processing module of the automatic comfort system. The server processor determines using the received ID information that the husband is driving, the wife is sitting in the front passenger seat, the older child is sitting behind the driver and the younger child is sitting in the rear passenger seat. The server processor gathers personal information related to each member of the family by searching a memory in the storage module of the automatic comfort system.

The server processor analyzes and correlates the personal information to generate control signal(s) that are customized for each family members for controlling comfort settings, such as the temperature, seat recline and sun-block screen location. For instance, the husband prefers the temperature in low 70s (e.g., 72-73° F.) and, when driving, likes to keep some distance from the handle while the wife prefers the temperatures in mid 70s (e.g., 74-76° F.) and likes her seat straight up when riding with her younger child behind her to give some space to the younger child in a bulky car seat. The couple also prefers to have the sun-block screen lowered for their younger child. Though the older child also prefers the temperature in low 70s, the server processor keeps the temperature of the rear seat areas in mid 70s because the younger child is still very young and thus susceptible to a low temperature. If the wife brings up the digital temperature knob from 75° F. to 78° F., however, the server processor gathers the input and generates a control signal that can adjust the temperature of the front passenger side accordingly.

When the family sedan reaches the younger child's nursery and the wife takes the younger child off the sedan to drop her off the nursery, the server processor turns off the air-conditioning fan for the front passenger side and adjusts the temperature of the rear seat areas to low 70s in accordance with the older child's preference. When the wife reenters the sedan after dropping her younger child, the server processor turns back on the air-conditioning fan. Next, the older child is dropped off in front of his school and the server processor generates a control signal to turn off the air-conditioning fan for the rear seat areas. When the husband gets off in front of his office, the wife moves to the driver's seat and goes to her mother's house to pick her up to go for a grocery shopping. The server processor adjusts the driver seats closer to the handle in accordance with the wife's preference. The server processor also adjusts the temperature of the driver side to 78° F. When the children's grandmother, who carries her own RFID tag, gets in the sedan and occupies the front passenger seat, the server processor adjusts the seat recline and the temperature in accordance with the grandmother's preference.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for providing a customized output based on data obtained using radio-frequency identification (RFID), the method comprising:
receiving, at a server, from at least one RFID reader, identification (ID) information stored in a plurality of RFID devices each carried by one of a plurality of individuals;
searching and gathering, at the server, data related to the plurality of individuals from at least one of a database and an online information source based on the ID information, wherein the database includes personal information corresponding to each of the plurality of individuals;
analyzing, at the server, the gathered data to update the personal information corresponding to each of the plurality of individuals;
searching, at the server, for additional data related to the plurality of individuals from at least one of the database and the online information source based on the updated personal information;
correlating, at the server, the gathered data and the updated personal information to derive relationships amongst the plurality of individuals; and
providing, at the server, a customized output for at least some of the plurality of individuals using at least one of the gathered data, the updated personal information and the derived relationships.

2. The method of claim 1, further comprising:
generating, at the server, for output to at least some of the plurality of individuals at least one question based in part on at least one of the gathered data, the updated personal information and the derived relationships; and
receiving and gathering, at the server, answers to the question from at least some of the plurality of individuals, wherein the customized output is further based on the gathered answers.

3. The method of claim 1, further comprising:
monitoring, at the server, a plurality of parameters related to a controlled system; and
detecting and gathering, at the server, inputs from at least one of the plurality of individuals indicating a change of at least one of the plurality of parameters, wherein the customized output is further based on the gathered inputs and includes a control signal provided to the controlled system.

4. The method of claim 1, wherein the plurality of RFID devices includes a plurality of RFID cards and/or RFID tags.

5. The method of claim 1, wherein the database is a remote database operated by a third party and wherein the server maintains a subscription with the third party for the remote database.

6. The method of claim 1, wherein searching from the databases includes making queries using an outcome of a search from the online information source in addition to the ID information and wherein searching from the online information source includes making queries using an outcome of a search from the database in addition to the ID information.

7. The method of claim 1, wherein correlating the gathered data and the updated personal information comprises:
pooling information in at least one category of the gathered data and the updated personal information; and
identifying any individuals from the plurality of individuals with matching information item within the category.

8. The method of claim 1, wherein the online information source includes a plurality of file transfer protocol (FTP) site, online storage site, web site, online auction site, online dating site, content site, e-commerce site, government site, school site, religious site, blog site, forum site, social media networking site, community site, online message board and online chat room.

9. An apparatus for providing a customized output based on data obtained using radio-frequency identification (RFID), the apparatus comprising:
one or more interfaces configured to provide communication with at least one node over a network; and
a processor, in communication with the one or more interfaces, configured to run a customized output generation module stored in memory that is configured to:
receive, from at least one RFID reader, identification (ID) information stored in a plurality of RFID devices each carried by one of a plurality of individuals;
search and gather data related to the plurality of individuals from at least one of a database and an online information source based on the ID information, wherein the database includes personal information corresponding to each of the plurality of individuals;
analyze the gathered data to update the personal information corresponding to each of the plurality of individuals;
search for additional data related to the plurality of individuals from at least one of the database and the online information source based on the updated personal information;
correlate the gathered data and the updated personal information to derive relationships amongst the plurality of individuals; and
provide a customized output for at least some of the plurality of individuals using at least one of the gathered data, the updated personal information and the derived relationships.

10. The apparatus of claim 9, wherein the customized output generation module run by the processor is further configured to:
generate for output to at least some of the plurality of individuals at least one question based in part on at least one of the gathered data, the updated personal information and the derived relationships; and
receive and gather answers to the question from at least some of the plurality of individuals, wherein the customized output is further based on the gathered answers.

11. The apparatus of claim 9, wherein the customized output generation module run by the processor is further configured to:
monitor a plurality of parameters related to a controlled system; and
detect and gather inputs from at least one of the plurality of individuals indicating a change of at least one of the plurality of parameters, wherein the customized output is further based on the gathered inputs and includes a control signal provided to the controlled system.

12. The apparatus of claim 9, wherein the plurality of RFID devices include a plurality of RFID cards and RFID tags.

13. The apparatus of claim 9, wherein the database is a remote database operated by a third party and wherein the apparatus maintains a subscription with the third party for the remote database.

14. The apparatus of claim 9, the customized output generation module run by the processor is further configured to search from the database by making queries using an outcome of a search from the online information source in addition to the ID information.

15. The apparatus of claim 9, wherein the customized output generation module run by the processor is further configured to search from the online information source by making queries using an outcome of a search from the database in addition to the ID information.

16. The apparatus of claim 9, wherein the customized output generation module run by the processor is further configured to:
pool information in at least one category of the gathered data and the updated personal information; and
identify any individuals from the plurality of individuals with matching information item within the one or more categories.

17. A non-transitory computer readable medium having executable instructions operable to cause an apparatus to:
receive, from at least one RFID reader, identification (ID) information stored in a plurality of RFID devices each carried by one of a plurality of individuals;
search and gather data related to the plurality of individuals from at least one of a database and an online information source based on the ID information, wherein the database includes personal information corresponding to each of the plurality of individuals;
analyze the gathered data to update the personal information corresponding to each of the plurality of individuals;
search for additional data related to the plurality of individuals from at least one of the database and the online information source based on the updated personal information;
correlate the gathered data and the updated personal information to derive relationships amongst the plurality of individuals; and
provide a customized output for at least some of the plurality of individuals using at least one of the gathered data, the updated personal information and the derived relationships.

18. The computer readable medium of claim 17, wherein the executable instructions are further operable to:
generate for output to at least some of the plurality of individuals at least one question based in part on at least one of the gathered data, the updated personal information and the derived relationships; and
receive and gather answers to the question from at least some of the plurality of individuals, wherein the customized output is further based on the gathered answers.

19. The computer readable medium of claim 17, wherein the executable instructions are further configured to:
monitor a plurality of parameters related to a controlled system; and
detect and gather inputs from at least some of the plurality of individuals indicating a change of at least one of the plurality of parameters, wherein the customized output is further based on the gathered answers and includes a control signal provided to the controlled system.

20. The computer readable medium of claim 17, wherein the online information source includes a plurality of file transfer protocol (FTP) site, online storage site, web site, online auction site, online dating site, content site, e-commerce site, government site, school site and religious site, blog site, forum web site, social media networking site, community site, online message board and online chat room.
